(19) United States
(12) Patent Application Publication
(10) Pub. No.: US 2011/0231313 A1
(43) Pub. Date: Sep. 22, 2011

(54) Creating and Utilizing an Image Replacement System

(75) Inventor: William C. Robinson, Annapolis, MD (US)

(73) Assignee: BANK OF AMERICA CORPORATION, Charlotte, NC (US)

(21) Appl. No.: 12/728,963

(22) Filed: Mar. 22, 2010

(51) Int. Cl. G06Q 40/00

(52) U.S. Cl. 705/43

(57) ABSTRACT

Aspects of this disclosure relate to a computer which may include a processor and memory storing computer executable instructions that, when executed, cause the computer to perform a method for preparing an image replacement document. According to aspects of the disclosure, the method may include electronically receiving a notification of a potential defect in a negotiable instrument, associated with a financial transaction, uploaded at an automated teller machine (ATM), electronically receiving an electronic copy of an image of the negotiable instrument uploaded at the ATM, and electronically receiving information regarding the financial transaction which included the negotiable instrument being uploaded at the ATM, wherein the information regarding the financial transaction includes an account number of an account into which funds of the negotiable instrument are to be credited.

### FIELD OF DISCLOSURE

Aspects of the present disclosure relate generally to image replacement documents. Particular aspects of the present disclosure relate to creating image replacement documents and leveraging the image replacement documents to increase the efficiency and reduce the expenses that are associated with particular business tasks.

### BACKGROUND

In the past, in order for a customer to conduct a financial transaction with a bank, or other financial institution, where the financial transaction involved a negotiable instrument (e.g., a check), the customer would typically have to enter a branch of the bank and conduct the financial transaction with a live representative of the bank. However, in recent years, financial transactions between a customer and a bank which involve negotiable instruments can be done by other methods (e.g., via an Automated Teller Machine). While it may be more convenient to conduct such financial transactions through these other methods, conducting such financial transactions through these methods may cause issues which have the potential to actually increase expense and reduce efficiency for the bank. It would be advantageous to have a system and method that increases the efficiency and reduces the expense associated with potential issues that may arise from using such methods to conduct such financial transactions between a customer and a bank.

### SUMMARY

In light of the above, it would be beneficial to provide a system and a method that increases the efficiency and reduces the expense that are caused by potential issues that may arise when a customer uses an automated teller machine (ATM) to conduct a financial transaction between a customer and a bank where the financial transaction involves a negotiable instrument.

Therefore, aspects of the disclosure may relate to a computer assisted method for creating and sending a negotiable instrument to an individual. According to aspects of the disclosure, the computer assisted method may include electronically receiving a notification of a potential defect in a negotiable instrument, associated with a financial transaction, uploaded at an ATM, electronically receiving an electronic copy of an image of the negotiable instrument uploaded at the ATM, and electronically receiving information regarding the financial transaction which included the negotiable instrument being uploaded at the ATM, wherein the information regarding the financial transaction includes an account number of an account into which funds of the negotiable instrument are to be credited. Further, according to aspects of the disclosure, the method may include using a computer to determine whether the potential defect is a defect that prevents an amount of funds of the negotiable instrument from being credited in the account, wherein the determination is based on a review of the electronic copy of the image of the negotiable instrument and the information regarding the financial transaction. Further, according to aspects of the disclosure, the method may include using a computer to prepare an image replacement document representing the negotiable instrument when it is determined that the potential defect is a defect that prevents the funds of the negotiable instrument from being credited in the account and sending the image replacement document to the individual.

Additionally aspects of this disclosure to a computer which may include a processor and memory storing computer executable instructions that, when executed, cause the computer to perform a method for preparing an image replacement document. According to aspects of the disclosure, the method may include electronically receiving a notification of a potential defect in a negotiable instrument, associated with a financial transaction, uploaded at an automated teller machine (ATM), electronically receiving an electronic copy of an image of the negotiable instrument uploaded at the ATM, and electronically receiving information regarding the financial transaction which included the negotiable instrument being uploaded at the ATM, wherein the information regarding the financial transaction includes an account number of an account into which funds of the negotiable instrument are to be credited. Further, according to aspects of the disclosure, the method may include determining, based on the electronic copy of the image of the negotiable instrument and the information regarding the financial transaction, whether the potential defect is a defect that prevents an amount of the funds of the negotiable instrument from being credited in account. Further, according to aspects of the disclosure, the method may include upon determining that the potential defect is a defect that prevents an amount of the funds of the negotiable instrument from being credited in the account, preparing an image replacement document.

Aspects of the disclosure may relate to a computer assisted method for creating and sending a negotiable instrument to an individual. According to aspects of the disclosure, the computer assisted method may include electronically receiving an electronic copy of an image of a negotiable instrument, associated with a financial transaction, uploaded at an ATM and electronically receiving information regarding the financial transaction which included the negotiable instrument being uploaded at the ATM, wherein the information regarding the financial transaction includes an account number of an account into which the funds of the negotiable instrument are to be credited. Further, according to aspects of the disclosure, the method may include using a computer to determine whether the financial transaction included a defect which prevents an amount of the funds of the negotiable instrument from being credited in the account, wherein the determination is based on a review of the electronic copy of the image of the negotiable instrument and the information regarding the financial transaction, using a computer to prepare an image replacement document representing the negotiable instrument upon determining that the financial transaction contained the defect that prevents an amount the funds of the negotiable instrument from being credited in the account and sending the image replacement document to the individual.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of a general-purpose digital computing environment in which certain aspects of the present disclosure may be implemented;

FIG. 2 illustrates a block diagram of a computing environment in which certain aspects of the present disclosure may be implemented;

FIGS. 3A and 3B illustrate a flow chart which describes an illustrative process for processing a negotiable instrument;

FIGS. 4A and 4B illustrate a front side and a back side respectively of an example of an image replacement document; and

FIGS. 5A and 5B illustrate a flow chart which describes an illustrative process for determining a defect with a negotiable instrument and returning an image replacement document to the customer according to aspects of the disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

It is noted that throughout the disclosure, the term business may be used interchangeably with organization, financial institution, bank, etc. The term business is not intended to be limiting, but rather merely describe a potential embodiment of the disclosure.

As described above, in the past, in order for a customer to conduct a financial transaction with a bank which involved a negotiable instrument the customer would typically have to enter a branch of the bank and conduct the financial transaction with a live representative of the bank. For example, if the customer was depositing a check at a bank, the customer would enter a branch of the bank and deposit the check by interacting with a live bank representative. In such an example, the customer may present the check to a bank teller at the teller's window or counter at the bank. During such interaction, the teller may examine the check and other documents involved in the transaction (e.g., a deposit slip) to ensure the financial transaction was in order. For example, the bank teller may determine if the deposit amount was correct, if the check was properly endorsed, if the payee name on the check was the same as the name of the account holder for the account into which the check was being deposited, etc. If the bank teller concluded that the information regarding the financial transaction was in order, the bank teller would deposit the check and issue a receipt to the customer indicating that the financial transaction was conducted (and potentially including other details of the financial transaction (e.g., a current balance)).

As also discussed above, in recent times, customers may now conduct such financial transactions (e.g., financial transactions which involve negotiable instruments) through other means which make the financial transaction more convenient for the customer. For example, a customer may now conduct such financial transactions (e.g., financial transactions which involve negotiable instruments) through an automated teller machine (ATM). An example of this process will be described below, where, for illustrative purposes, the negotiable instrument is a check and the financial transaction includes depositing the check at an ATM.

Initially, a customer may approach the ATM and insert her bank card and pin number in order to access the customer's one or more financial accounts with the bank. Thereafter, the ATM may be configured to present the customer with one or more options of financial transactions to conduct. The customer may choose a selection which allows the customer to deposit the check into one of the customer's respective financial accounts (e.g., a checking or savings account). Upon the customer's selection to deposit a check, the ATM may prepare to receive the check from the customer. For example, the ATM may provide an access point through which the customer may manually insert one or more checks into the ATM. For example, the ATM may automatically open a cover which covers the access point. Alternatively, if the access point is already available to the customer, the ATM may merely prepare a conveying system associated with the access point to receive the check. It is noted that the conveying system may include conveying rollers, belts, etc. or other sheet feeding devices for conveying paper as is known in the art. Once the ATM is prepared to receive the check, the ATM may indicate this status to the customer. For example, the ATM may be configured to display a visual message on the display screen of the ATM that instructs the customer to insert the check and/or may provide an audible cue to the customer that the ATM is ready to receive the one or more checks. Thereafter, the customer may manually upload the check to the ATM by inserting the check into the access point of the ATM and letting the ATM conveying system convey the check through the ATM so that it may be processed as will be described in detail below.

Conducting such a financial transaction at an ATM may be convenient for the customer because, for example, the customer does not have to conduct the financial transaction during the normal business hours of the bank. Instead, the customer may conduct the financial transaction at her convenience which may be outside of the bank's normal business hours. Further, the customer may conduct the financial transaction without having to wait in line to interact with a live bank teller. Instead, if the customer realizes that the wait, if any, would be shorter at the ATM, the customer may conduct the financial transaction at the ATM instead of the bank counter with the live teller.

Additionally, having a customer conduct such a financial transaction at an ATM, instead of with a live teller, may be efficient and cost effective for the bank itself. For example, if the bank teller is not occupied with interacting with the customers, she may have more time to perform other duties. Therefore, it is understood that the opportunity for a customer to conduct such a financial transaction through an ATM (or other convenient means) may be beneficial for both the customer and the bank.

While conducting such financial transactions through other methods may be beneficial for both the customer and the bank, it also may cause issues which have the potential to reduce efficiency and increase expense for the bank. Further, it also may cause potential non-beneficial issues for the customer.

For example, there may be a defect with the financial transaction or the negotiable instrument itself that prevents the funds from being credited to the account designated by the customer. For example, one such defect may arise when a customer attempts to deposit a check made payable to a business into a personal account of the customer. Another example may be when a customer attempts to deposit a check where the payee on the check does not match the name of the account holder(s). For example, if a check is made out to both a husband and wife and the husband attempts to the deposit the check into a personal account where the wife's name is not included as an account holder, the financial transaction may be considered defective. Another example may be when a customer attempts to deposit a check that is not correctly endorsed. For example, if the check is missing one or more signatures or, alternatively, contains too many signatures the check may be considered defective.

If the financial transaction involving the negotiable instrument has a defect (such as described above) that would prevent the funds associated with the negotiable instrument from being credited to the customer's account, then, if the financial transaction was conducted with a live teller, the teller has an opportunity to realize the issue, not accept the negotiable instrument and, instead, return it to the customer immediately at the counter. However, if the financial transaction was conducted through an ATM, there may not be a similar opportunity to refuse the negotiable instrument and return it to the customer immediately. Therefore, if the ATM does, in fact, accept a defective negotiable instrument (defective in the sense that the funds may not be properly created to the account) and improperly credits the customer's account with the funds, then, when the bank realizes the error, the bank will withdraw, or debit, the funds from the account, and return a negotiable instrument to the customer along with a notice that contains a recordation that the funds were debited from the account and, also, the reason why the financial transaction or negotiable instrument was defective. As will be described below, this process may be time consuming, tedious and expensive for the bank. Further, the time for the customer to receive the returned negotiable instrument from the bank may be relatively lengthy. This may be an inconvenience for the customer because, for example, the customer may not be able to deposit funds in the proper account until the customer receives the returned negotiable instrument from the bank.

It would be advantageous to have a system and method that increases the efficiency and reduces the expense associated with returning negotiable instruments to a customer as a result of a defect in the financial transaction conducted between a customer and the bank. Therefore, aspects of this disclosure relate to a system and method for increasing the efficiency with which a bank returns a negotiable instrument to customer if the negotiable instrument is improperly credited to a customer's financial account. Further, aspects of this disclosure relate to a system and method for reducing the expense a bank incurs to identify and return a negotiable instrument to a customer when the negotiable instrument is improperly credited to the customer's financial account. Additionally, aspects of the disclosure relate to a method and system for reducing the time it takes for a customer to receive a negotiable instrument from a bank when a negotiable instrument has been improperly credited to a customer's account.

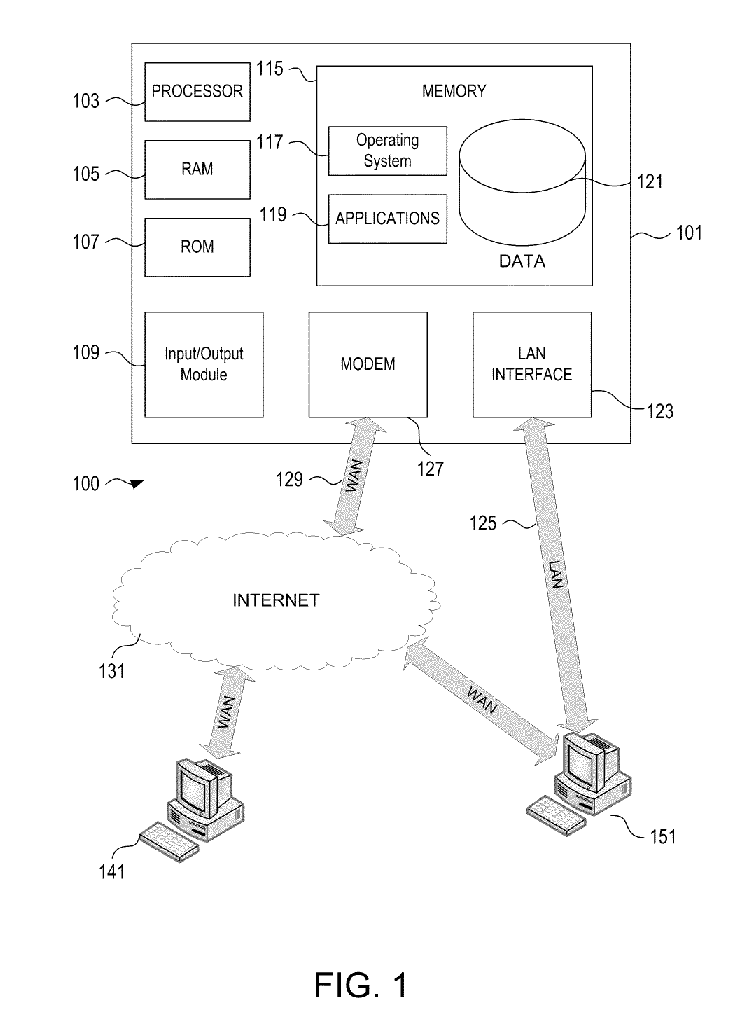

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile discs (DVD) or other optical disc storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more applications representing the application data stored in RAM memory 105 while the computer is on and corresponding software applications (e.g., software tasks), are running on the computer 101.

Input/output module 109 may include a microphone, keypad, touch screen, check deposit access point, ATM card access point, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151 or computers. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communication link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

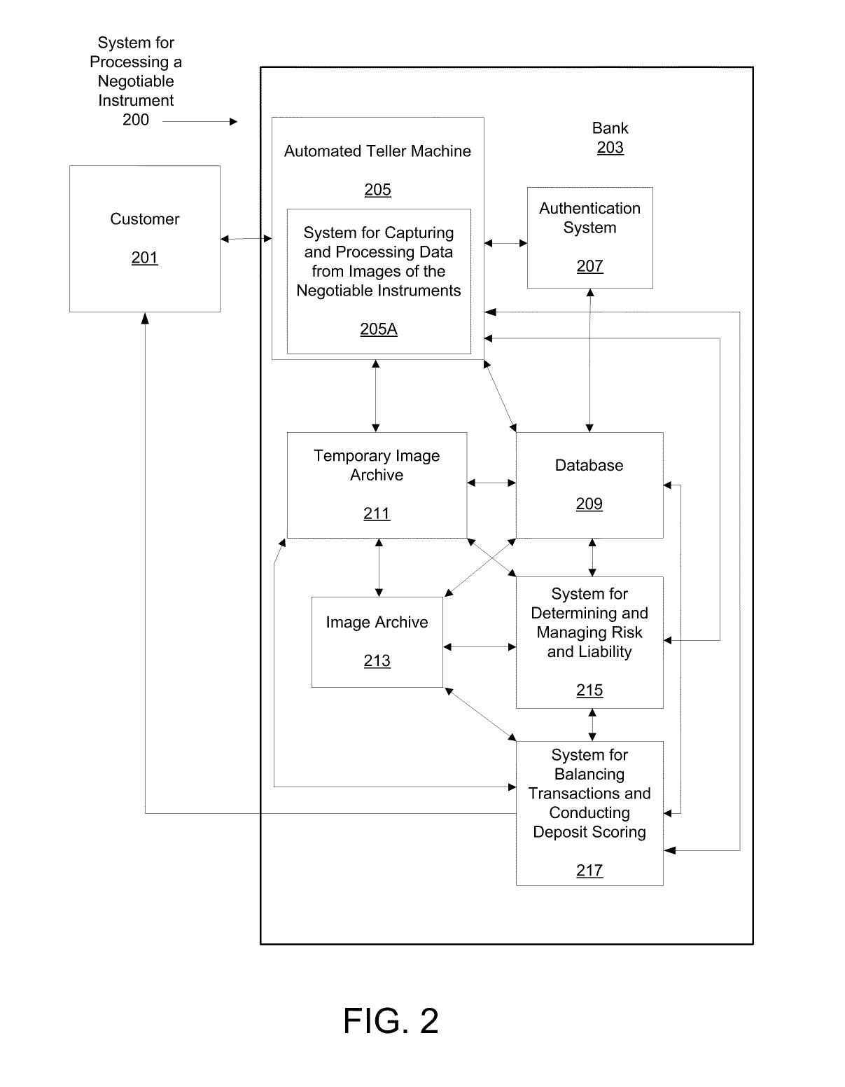

FIG. 2 is a diagram which shows an illustrative system 200 for processing a negotiable instrument according to aspects of this disclosure. As seen in FIG. 2, a customer 201 conducts a transaction with a bank 203 at an ATM 205. According to aspects of this disclosure, the customer 201 may have to authenticate her identity in order to conduct the transaction. Therefore, as seen in FIG. 2, the system 200 may include an authentication system 207 and one or more databases 209 which store data related to various aspects of the bank, including, customer information, account information, etc. The authentication system 207 may transmit data to and receive data from one or more of the databases 209 which confirms the identity of the customer 201 conducting the transaction. Further, according to aspects of the disclosure, the system for processing a negotiable instrument 200 may include a temporary image archive 211 and image archive 213. Additionally, the system for processing a negotiable instrument 200 may include a system for determining and managing risk and liability 215 and a system for balancing transactions and conducting deposit scoring 217. The ATM 205 may include a system 205a for capturing and processing data from images of negotiable instruments that are created at the ATM 205 (as will be described in detail below). As seen in FIG. 2, the ATM 205 may be configured to transmit data to and receive data from the authentication system 207, one or more of the databases 209, the temporary image archive 211 and the other systems within the bank 203 including the system for determining and managing risk and liability 215 and the system for balancing transactions and conducting deposit scoring 217. Further, as seen in FIG. 2, the temporary image archive 211 and the image archive 213 may transmit data to and receive data from each other, one or more of the databases 209, and others systems within the bank including the system for determining and managing risk and liability 215 and the system for balancing transactions and conducting deposit scoring 217. Further, according to aspects of the disclosure, and as seen if FIG. 2, the system for determining and managing risk and liability 215 and the system for balancing transactions and conducting deposit scoring 217 may transmit data to and receive data from each other and one or more of the databases 209.

The above described system 200 represented in FIG. 2 will be described in more detail below. However, it is noted here that one or more of the elements in the above described system for processing a negotiable instrument 200 (e.g., ATM 205, the system for capturing and processing data for images of the negotiable instruments 205A, authentication system 207, database 209, temporary image archive 211, image archive 213, the system for determining and managing risk and liability 215 and the system for balancing transactions and conducting deposit scoring 217) may include a computer system with a processor, a memory or both.

As mentioned above, the process for conducting a financial transaction between a customer and a bank via an ATM, where the financial transaction involves a negotiable instrument will be described in further detail below. It is noted that while this process is described with respect to a deposit of a check, this embodiment is not meant to be limiting and, instead, other negotiable instruments may be applicable if desired.

Initially, it is noted that, in addition to the computer system 205A and conveying system for receiving and conveying paper checks throughout the ATM, which are described above, according to aspects of the disclosure, the ATM 205 may include a display device (e.g., a video screen), a keypad or voice activation system for receiving input (e.g., input from the customer), a processor, a memory, a bank card receiving system for receiving, reading and returning a bank card, a scanning device (e.g., a scanner) for creating an electronic image of a check, a printer, a lockable container configured to hold banknotes, a lockable container configured to hold checks received by the ATM 205, and means for receiving and transmitting data to other computer systems associated with the ATM 205.

As seen in FIG. 2, and as described in detail above, initially, a customer 201 uploads a check to the ATM 205. Once the ATM 205 has received the check, it may be conveyed via the conveying system to a scanning device of the ATM 205 that is configured to scan the check and create an electronic image of the check. An electronic image of the check may be displayed on a display screen of the ATM 205 for the customer to review. Further, an electronic image of the check may be printed via a printing system on a receipt of a transaction that is provided to the customer 201. For example, the printing system of the ATM 205 may receive image data regarding the electronic copy of the check and utilize such data to create an electronic copy of the check on a receipt for the customer. Of course, the receipt may include additional data such as the amount of the transaction, the current balance, date of the transaction, routing and account numbers, etc.

According to aspects of the disclosure, an electronic image of the check may be stored in a memory of the ATM 205. For example, according to aspects of the disclosure, an electronic image of the check may be stored in a memory of the ATM for a predetermined amount of time (e.g., one or two days). Additionally, it is noted that according to aspects of the disclosure, the actual paper checks from which electronic images are created may also be stored at ATM 205 in lockable containers as described above. Periodically (e.g., daily), the ATMs 205 may be serviced and the paper checks are retrieved from the ATM 205 and sent to a separate storage location to be stored. For example, larger banks may have a plurality of storage locations throughout the country for storing the paper checks.

According to aspects of the disclosure, an ATM 205 may have a system 205A that captures and processes data from the electronic copy of the check and stores such data in a memory of the ATM. For example, system 205A may include optical character recognition (OCR) software or the like which configures the system 205A to capture and process data from the electronic image of the check. Therefore, information from the electronic image of the check including the payor's name and address, the payee's name, the monetary amount for which the check is written, the routing number, the account number, the check number, the date the check was written, the bank from which the check originated, etc., may be captured and processed. Additionally, according to aspects of the disclosure, and as seen in FIG. 2, the system 205A may be configured to transmit the data extracted from the electronic image of the check. For example, the system 205A may be configured to transmit the data to other computer systems or databases within the bank, such as the database(s) 209 or the system for determining and managing risk and liability 215 and the system for balancing transactions and conducting deposit scoring 217. Further, it is noted that the data extracted from the electronic images of the checks that is received at the database 209 may be associated and stored accordingly. For example, the information may be associated and stored in accounts associated with the payee, e.g., customer, of the check.

According to aspects of the disclosure, the system 205A may be configured to recognize potential defects with the electronic images of the checks that may prevent the funds associated with the check from being credited to the customer's account. For example, the system 205A may be configured to recognize if the payee on the check does not match the account holder of the account into which the check is to be deposited. Another example may be that the system 205A may be configured to determine if the check is missing one or more signatures or, alternatively, contains too many signatures. Further, according to aspects of the disclosure, upon such a determination that there may be a potential defect that may prevent the funds associated with the check from being credited to the customer's account (such as described above), the system 205A may create a notification that is transmitted to the system for determining and managing risk and liability 215. For example, the system 205A may automatically “flag” the transaction and create a notification where it instructs the system for determining and managing risk and liability 215 to conduct a review of the financial transaction. According to aspects of the disclosure, the determination of the potential defect that may prevent the funds associated with the check from being credited to the customer's account and the creation of a notification of such a potential defect may be originated and transmitted shortly after the electronic image of the check has been created (e.g., within minutes of the check being uploaded).

According to aspects of the disclosure, the system 200 may include a temporary image archive 211 to which the electronic images of the checks are transmitted from the ATM 205. According to aspects of the disclosure, the temporary image archive 211 may include an electronic server and database. For example, according to aspects of the disclosure the temporary image archive 211 may include a Check Image Management System (CIMS) database. It is noted that the software used for operating the temporary image archive 211 that stores the electronic check images may be CIMS software distributed by International Business Machines (IBM) of Armonk, N.Y. According to aspects of the disclosure, an electronic image of the check may be transmitted from the ATM 205 to the temporary image archive 211 within a predetermined amount of time from when the electronic image of the check is created at the ATM 205 (e.g., 30 minutes from the electronic image of the check being created at the ATM 205).

As described above, according to aspects of the disclosure, the system 200 may include an image archive 213. Further, according to aspects of the disclosure, an electronic image of the check may be electronically transmitted from the temporary image archive 211 to the image archive 213. According to aspects of the disclosure, the image archive 213 may include an electronic server and database. Further, according to aspects of the disclosure, an electronic image of the check may be stored on the image archive 213 for a predetermined amount of time (e.g., 60-90 days from the date that the electronic image of the check is initially stored on the image archive 213). It is noted that after the predetermined amount of time, the image of the check may be transferred to tape or other storage medium.

According to one or more aspects of the disclosure, a bank may have one or more systems that are configured to conduct various tasks associated with the day-to-day functions of the bank 203. For example, according to aspects of the disclosure, such systems may include a system for determining and managing risk and liability 215 and a system for balancing transactions and conducting deposit scoring 217. It is noted that such systems may include computer systems that may be configured to search for, indentify, extract, or otherwise receive, and process data from the above described elements of the system for processing negotiable instruments 200. For example, the computer systems 215 and 217 may search the information stored in the database(s) 209 for account information of customers of the bank. Further, according to aspects of the disclosure, the computer systems 215 and 217 may be configured to search for, indentify, extract, or otherwise receive, and process data stored in the temporary image archive 211 and the image archive 213 (e.g., particular electronic images of the checks that are stored in the temporary image archive 211 and the image archive 213 as described above).

According to aspects of the disclosure, the system for balancing transactions and conducting deposit scoring 217 may include one or more computer systems that are configured to process the financial transactions that occur throughout the bank 203 and ensure that the accounts are correctly credited or debited based on such transactions. For example, financial transactions that occur throughout the bank 203 may cause funds to be withdrawn, transferred, deposited, etc. in various accounts. Therefore, in order to ensure that the correct amount of funds was withdrawn, transferred, deposited, etc. appropriately, the system for balancing transactions and conducting deposit scoring 217 may be configured to review the accounts of the bank 203 and ensure they are balanced based on associated financial transactions.

With respect to the above described illustrative example of a financial transaction according to aspects of the disclosure, where a check is deposited into an account via an ATM 205, the system for processing the negotiable instrument 200 automatically may preliminarily and tentatively credit to the customer's account with the amount of funds indicated in the check. If the check is free of defects and the funds indicated in the check are allowed to be deposited in the customer's account, then the system for balancing transactions and conducting deposit scoring 217 will determine that the customer's account balance correctly reflects the credit.

However, in a situation wherein it is determined that the financial transaction is defective and the funds were improperly credited to the account (e.g., such as one of the situations described above wherein the funds should not have been credited in the first place), the system for balancing transactions and conducting deposit scoring 217 is configured to debit the customer's account for the same amount that was improperly included in the account. For example, as described above, according to aspects of the disclosure, the computer for capturing and processing data from the image of the negotiable instruments 205A may notify the system for determining and managing risk and liability 215 of a particular financial transaction and negotiable instrument that is to be reviewed. According to aspects of the disclosure, the review may include a manual review by an employee of the bank. Upon review, if it is determined that the funds were, in fact, improperly credited to the account, then the system for determining and managing risk and liability 215 may send a request to the system for balancing transactions and conducting deposit scoring 217 that the customer's account is to be debited for the same amount that was improperly included in the account. According to aspects of the disclosure, the request for debiting of the account may be recorded in a debit/credit notice (DCN). According to aspects of the disclosure, the system for balancing transactions and conducting deposit scoring 217 may debit the account based on the DCN. Further, it is noted that, in addition to the request, the DCN may also contain the rationale for such debiting (e.g., the particular defect).

According to aspects of the disclosure, when the check cannot be deposited into the account, (e.g., such as one of the situations described above where the check contains a defect), the bank 203 may notify the customer 201 of the situation. Therefore, according to aspects of the disclosure, the system for balancing transactions and conducting deposit scoring 217 is configured to return a negotiable instrument along with a copy of the DCN to the customer 201 who attempted to deposit the check.

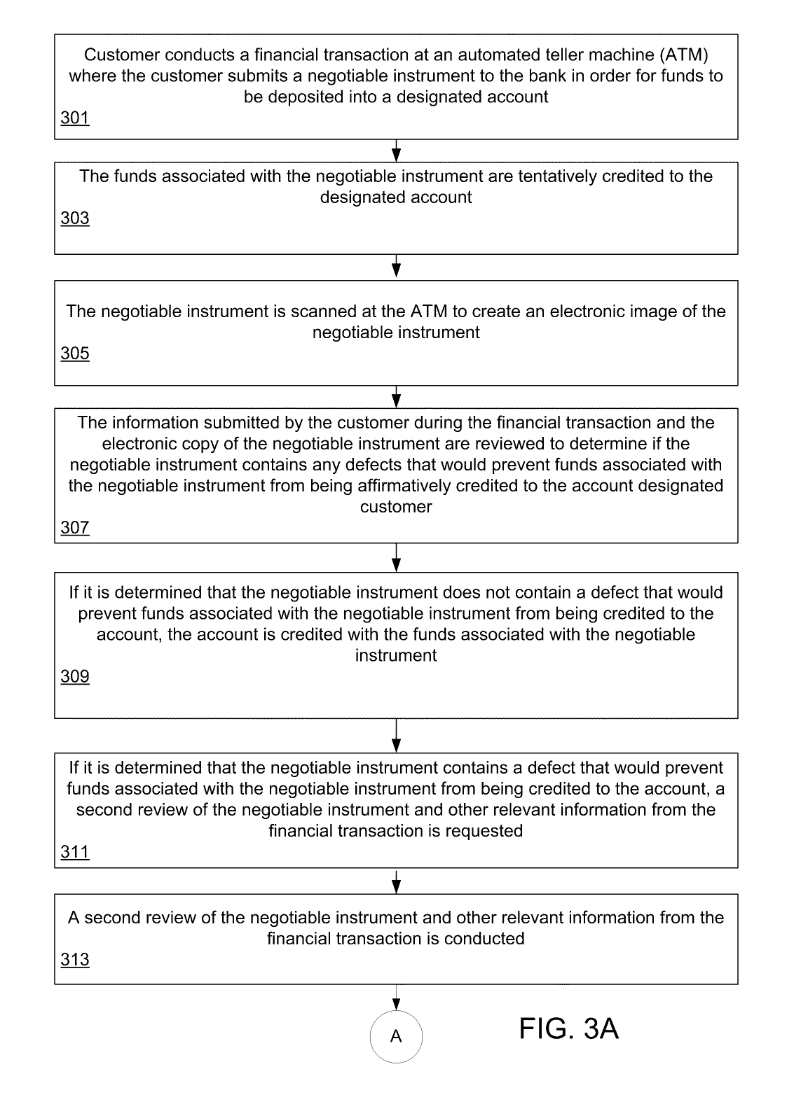

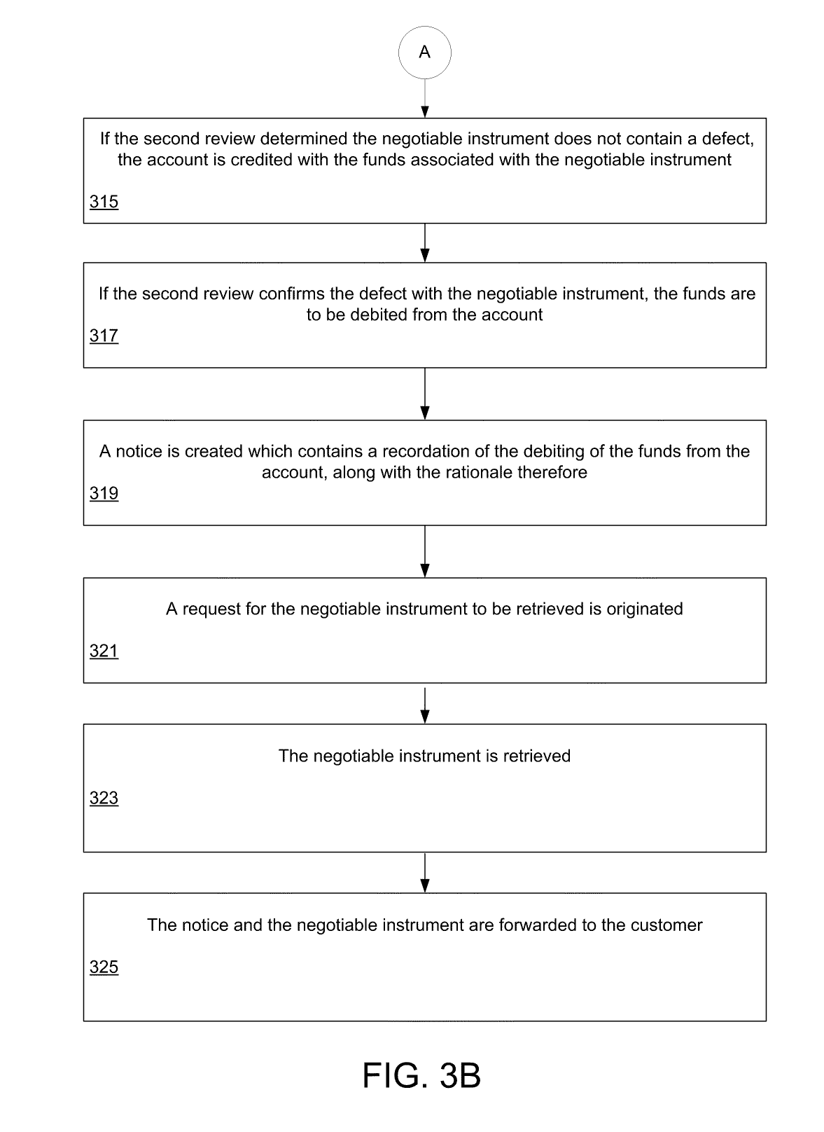

FIGS. 3A and 3B are a flow chart showing an illustrative method for processing a negotiable instrument according to aspects of the disclosure. As seen in FIG. 3A, in step 301 a customer conducts a financial transaction at an automated teller machine (ATM) where the customer submits a negotiable instrument to the bank in order for funds to be deposited into a designated account. In step 303, the funds associated with the negotiable instrument are tentatively credited to the designated account. In step 305, the negotiable instrument is scanned at the ATM to create an electronic image of the negotiable instrument. In step 307, the information submitted by the customer during the financial transaction and the electronic copy of the negotiable instrument are reviewed to determine if the negotiable instrument contains any defects that would prevent funds associated with the negotiable instrument from being affirmatively credited to the account designated customer. In step 309, if it is determined that the negotiable instrument does not contain a defect that would prevent funds associated with the negotiable instrument from being credited to the account, the account is credited with the funds associated with the negotiable instrument. In step 311, if it is determined that the negotiable instrument contains a defect that would prevent funds associated with the negotiable instrument from being credited to the account, a second review of the negotiable instrument and other relevant information from the financial transaction is requested. In step 313, a second review of the negotiable instrument other relevant information from the financial transaction is conducted. Proceeding to FIG. 3B, in step 315, if the second review determines the negotiable instrument does not contain a defect, the account is permanently credited with the funds associated with the negotiable instrument. In step 317, if the second review confirms the defect with the negotiable instrument, the tentatively credited funds are to be debited from the account. In step 319, a notice is created which contains a recordation of the debiting of the funds from the account, along with the rationale therefore. In step 321, a request for the negotiable instrument to be retrieved is originated. In step 323, the negotiable instrument is retrieved. In step 325 the notice and the negotiable instrument are associated and both are forwarded to the customer. It is noted that this process may be conducted via a computer system as described in detail above.

As discussed above, while financial transactions involving negotiable instruments may be conducted through an ATM and such financial transactions may be convenient and beneficial for both the customer and the bank, such financial transactions also may cause the above described issues which have the potential to reduce efficiency and increase expense for the bank. Further, such financial transactions also may cause potential non-beneficial issues for the customer. For example, as mentioned above, there may be a defect with the financial transaction or negotiable instrument that prevents the funds from being credited to the customer's account. As discussed above, example issues may include a customer depositing a check made payable to a business into a personal account of the customer, a customer attempting to deposit a check wherein the payee on the check does not match the name of the account holder(s), and a customer attempting to deposit a check that is not correctly endorsed. It is noted that in larger banks, these situations may occur in excess of 45,000 times per month.

If such a defective financial transaction involving the negotiable instrument is conducted at an ATM, then, as described above, the bank may return a negotiable instrument to the customer along with a notice (e.g., a DCN) which shows the account being debited for the amount that the account was preliminarily credited based on the ATM transaction. Further, the notice may contain a rationale as to why the check is not being credited to the account.

In the past, the original paper check was retrieved and returned to the customer. However, the process of retrieving the check and returning it to customer with the DCN was time consuming, tedious and expensive for the bank. Further, the time for the customer to receive the returned negotiable instrument from the bank was relatively lengthy. This was an inconvenience for the customer because the customer could not deposit funds in the proper account until they received the returned check from the bank.

The above described process of retrieving and returning a check to the customer included an ATM transmitting a notice to a first business unit within the bank that there was a potential issue with a particular check that may prevent the funds from being credited to the account designated by the customer. After receiving the notice, a business unit (e.g., a business unit responsible for determining and managing risk and liability) would conduct a manual review of the electronic image of the check to determine if there was, in fact, a defect. If so, the first business unit would originate a request to have the funds debited from the account, create a DCN regarding the debiting of the funds from the account and forward the DCN to the customer. Further the first business unit would forward the DCN to a second business unit within the bank (e.g., a business unit for balancing transactions and conducting deposit scoring) and request that the second business unit debit the funds from the account, retrieve the check, associate the check with the DCN and forward both the check and the DCN to the customer.

The second business unit would originate a request to have the original paper check pulled from the storage location at which it was held. As described above, paper checks submitted at ATMs are routinely collected by the bank and forwarded to various storage locations throughout the country. Therefore, once the second business unit determined the particular storage location at which the check is held, the second business unit would forward the request to have the original paper check pulled from that storage location and sent to the second business unit. This process of obtaining the original check from the storage location and forwarding it to the second business unit would potentially take several days. Further, the time may be increased if the check had not yet arrived at the storage location. For example, it may have taken several days for the original paper check to have been pulled from the ATM at which it was uploaded and then forwarded to the storage location.

Once the original check is received at the second business unit, the second business unit would associate the check with the DCN and forward both the DCN and the original paper check to the customer. For example, the second business unit would mail the items to the customer. In addition to the time required to retrieve the original paper check, the process of mailing the DCN and the original paper check to the customer may also have taken several days because the mail would take at least a couple of days to reach the customer. Hence, it is understood that in some cases, the process could take a relatively lengthy time to complete (e.g., 10 days or so), require many different tasks from different employees of the bank and cause the customer to have to wait a relatively lengthy time to receive the returned original check. Further, it is noted that in the above process, the customer would receive multiple DCNs. Therefore, aspects of the disclosure are directed to a method and system that overcomes the drawback of the above process by reducing the expense and increasing the efficiency of the process for returning negotiable instruments to the customer when the financial transaction conducted at the ATM contains a defect.

According to aspects of the disclosure, in order to substantially reduce the drawbacks of the above described process, the bank may utilize the captured image environments of the above described system 200 in which the electronic images of the original check are created. For example, according to aspects of the disclosure, instead of retrieving the original check, the bank may create and utilize an image replacement document (IRD) and forward the IRD to the customer along with the DCN. This action substantially increases the efficiency of the process for the bank. Also, this action substantially reduces expense for the bank. Further, this action substantially reduces the time the customer has to wait to receive a negotiable instrument with which she may conduct financial transactions.

An IRD is a negotiable instrument which represents the original paper check and becomes the legal equivalent of the original paper check. For example, under the Check Clearing for the 21^{st} Century Act, an IRD may take the place of (i.e., be a substitute for) the original check. In fact, an IRD is commonly referred to as a “substitute check.” There are several requirements to which a document must conform in order to be recognized as an IRD. For example, the IRD must accurately represent all the information depicted on the check (both front and back) at the time the bank truncated the original check. Further, the IRD must accurately represent the MICR line of the original check. Additionally, the IRD must include the statement, “This is a legal copy of your check. You can use it the same way you would use the original check.” Also, the bank that truncated the original check must provide a warranty for the IRD. Also, the bank that truncated the original check must follow ASC X9 standards in the capture of the check images and MICR data for the production of the IRD. Under, the Check Clearing for the 21^{st} Century Act, once a bank truncates the original check in favor of the substitute check, the bank may store, archive or destroy the original checks (or return them to the customer if required by state law).

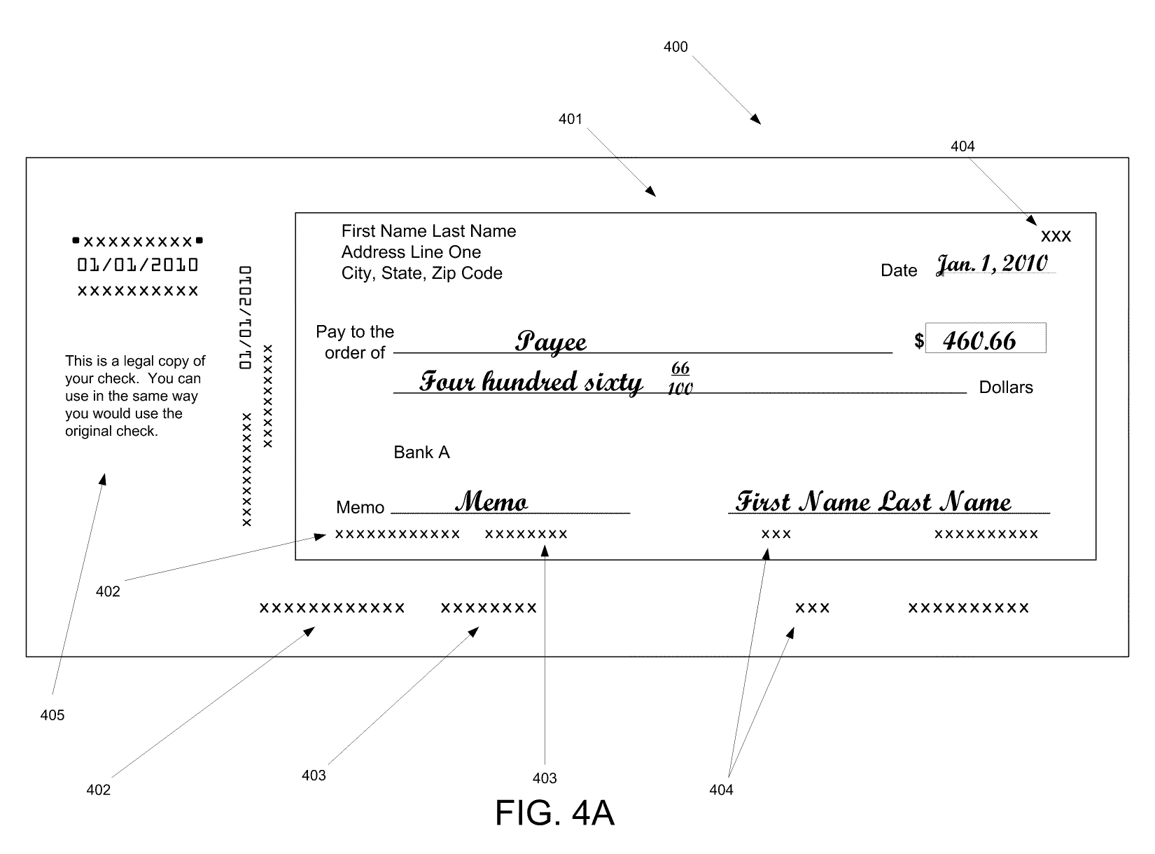

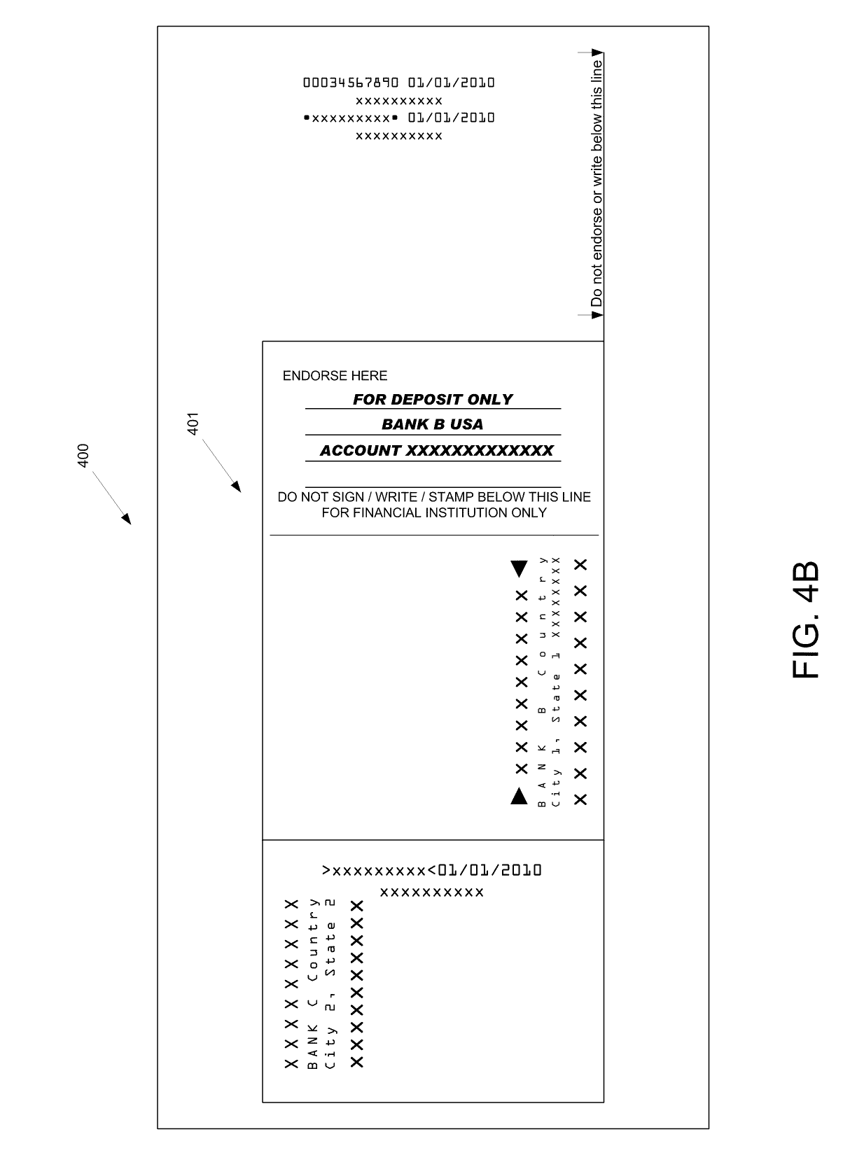

FIGS. 4A and 4B illustrate a front side and a back side, respectively, of an illustrative example of an IRD. As seen in FIG. 4A, the front side of the IRD 400 includes a reproduction of the original check 401. For example, as seen in FIG. 4A, the IRD 400 includes the original check information required to conform to the requirements of an IRD, including the routing number 402, account number 403, check number 404, etc. Further, as seen in FIG. 4A, the IRD 400 includes the required statement 405, “This is a legal copy of your check. You can use it the same way you would use the original check.”

Aspects of the disclosure relate to a system and method for creating and utilizing IRDs to return to a customer in situations where a financial transaction conducted by a customer at the ATM involved a negotiable instrument that cannot be credited to the account designated by the customer for various reasons (such as the issues described above).

The system and method according to aspects of the disclosure includes an ATM 205 transmitting a notice to the system for determining and managing risk and liability 215 that there is a potential defect with a particular financial transaction or check that may prevent the funds associated with the check from being credited to the account designated by the customer. After receiving the notice, the system for determining and managing risk and liability 215 may conduct a review of the electronic image of the check and information associated with the financial transaction (e.g., account into which the funds are to be placed, etc.). According to aspects of the disclosure, the system for determining and managing risk and liability 215 may obtain an electronic image of the check from the temporary image archive 211 or the image archive 213. Further, according to aspects of the disclosure, the system for determining and managing risk and liability 215 may obtain information associated with the financial transaction (e.g., the account into which the funds are to be placed, etc.) from the computer for capturing and processing data from an image of the negotiable instrument 205A or the database(s) 209. According to aspects of the disclosure, if desired, a user may conduct a manual review of the electronic image of the check and the information associated with the financial transaction in order to determine if there is, in fact, a defect. However, this is not required.

If the system for determining and managing risk and liability 215 determines there is a defect that prevents the funds from being credited to the account, the system for determining and managing risk and liability 215 originates a request for the funds to be debited from the account. The request may be in the form of a DCN regarding the debiting of the funds from the account. Further, the system for determining and managing risk and liability 215 transmits the DCN to the system for balancing transactions and conducting deposit scoring 217. For example, the DCN may be transmitted electronically.

Upon receiving the DCN from the system for determining and managing risk and liability 215, the system for balancing transactions and conducting deposit scoring 217 may retrieve an electronic image of the original check from the temporary image archive 211 or the image archive 213. Further, according to aspects of the disclosure, the system for balancing transactions and conducting deposit scoring 217 may use the electronic image of the original check to create an IRD which becomes the legal equivalent of the original check. For example, the IRD may be created by conforming to the above described requirements for creating an IRD. Further, it is noted that the IRD may be printed on printers specifically designed to create IRDs (e.g., micro-printers) and on paper specifically designed for IRDs. According to other aspects of the disclosure, the IRD may be kept its electronic format.

Regardless of the format of the IRD, once the IRD is created, it may be associated with a copy of the DCN. The IRD and the copy of the DCN may be forwarded to the customer. For example, the IRD and the copy of the DCN may be mailed (e.g., via regular mail or electronic mail depending on the format of the IRD) to the customer. It is noted that the above described process may be accomplished the same day that check is uploaded to the ATM. Therefore, according to aspects of the disclosure wherein the IRD and the copy of the DCN are electronically mailed to the individual (e.g., the customer that deposited the check), the delay in receiving the IRD and the copy of the DCN is greatly reduced. For example, according to aspects of the disclosure, the individual (e.g., the customer that deposited the check), may receive the IRD and the copy of the DCN the same day they deposited the check. Further, according to aspects of the disclosure, the IRD and the copy of the DCN may be uploaded to a website (e.g., a bank website corresponding to the customer's financial account with the bank). Thereafter, the customer may access the website (e.g., by electronically accessing their account) and download the IRD and the copy of the DCN. It is noted that other methods of electronically transmitting the IRD and the copy of the DCN to the customer (or otherwise electronically making the IRD and the copy of the DCN accessible to the customer) may be used as desired.

Further, according to aspects of the disclosure wherein the IRD and the copy of the DCN are mailed via regular mail to the individual (e.g., the customer that deposited the check), the delay in receiving the IRD and the copy of the DCN is still greatly reduced. For example, the time it takes for the customer to receive the IRD and DCN in the mail would be the only significant delay in the customer receiving the IRD and DCN. Hence, it is understood that, the above described system and process according to aspects of the disclosure may take a relatively short time to complete (e.g., same day or 2-3 days or so, depending almost entirely on the method through which the IRD and the copy of the DCN are made accessible to the individual). Further, it is understood that the system and method for returning a negotiable instrument to the customer according to aspects of the disclosure, substantially increases the efficiency of the bank. For example, by creating and leveraging the IRDs, the above described system and process according to aspects of the disclosure significantly reduces in the amount of different tasks and different employees of the bank involved in returning a negotiable instrument. For example, the original check no longer has to be retrieved from a storage location and, therefore, any tasks associated with such retrieval are eliminated. Further, it is noted that in the system and method for returning a negotiable instrument to the customer according to aspects of the disclosure, the customer may receive only a single DCN (e.g., the DCN accompanying the IRD). Therefore, it is understood that the methods and systems of the disclosure reduce the expense and increase the efficiency of the process for returning negotiable instruments to the customer.

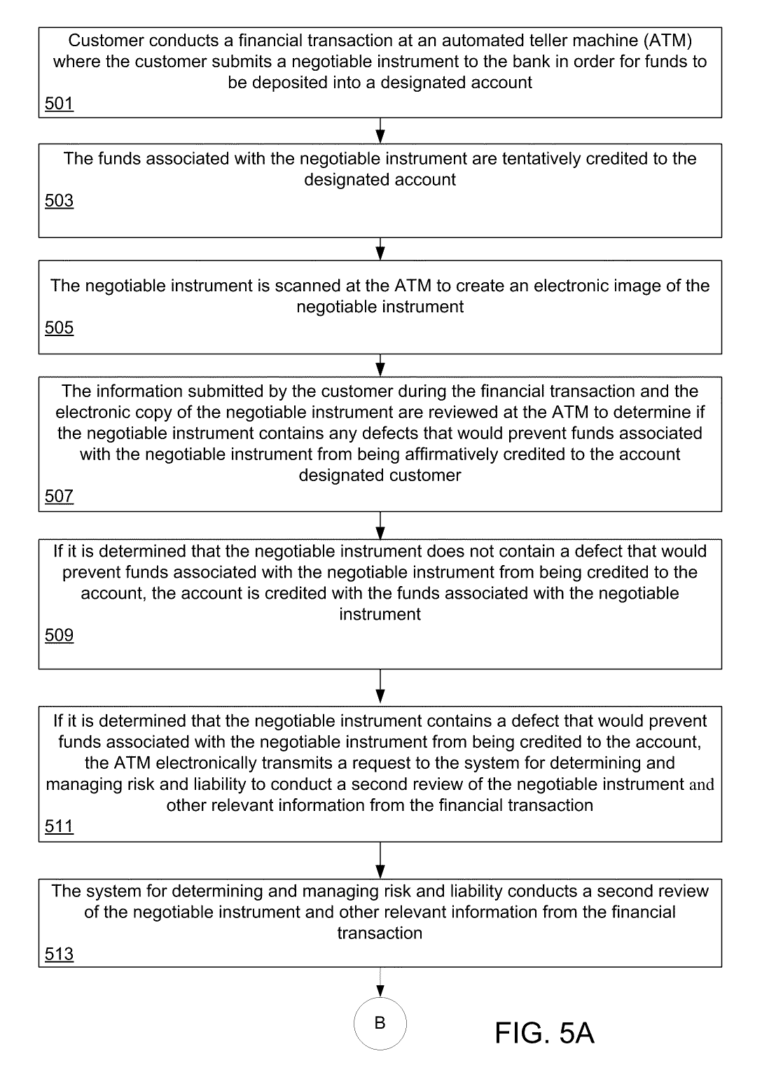

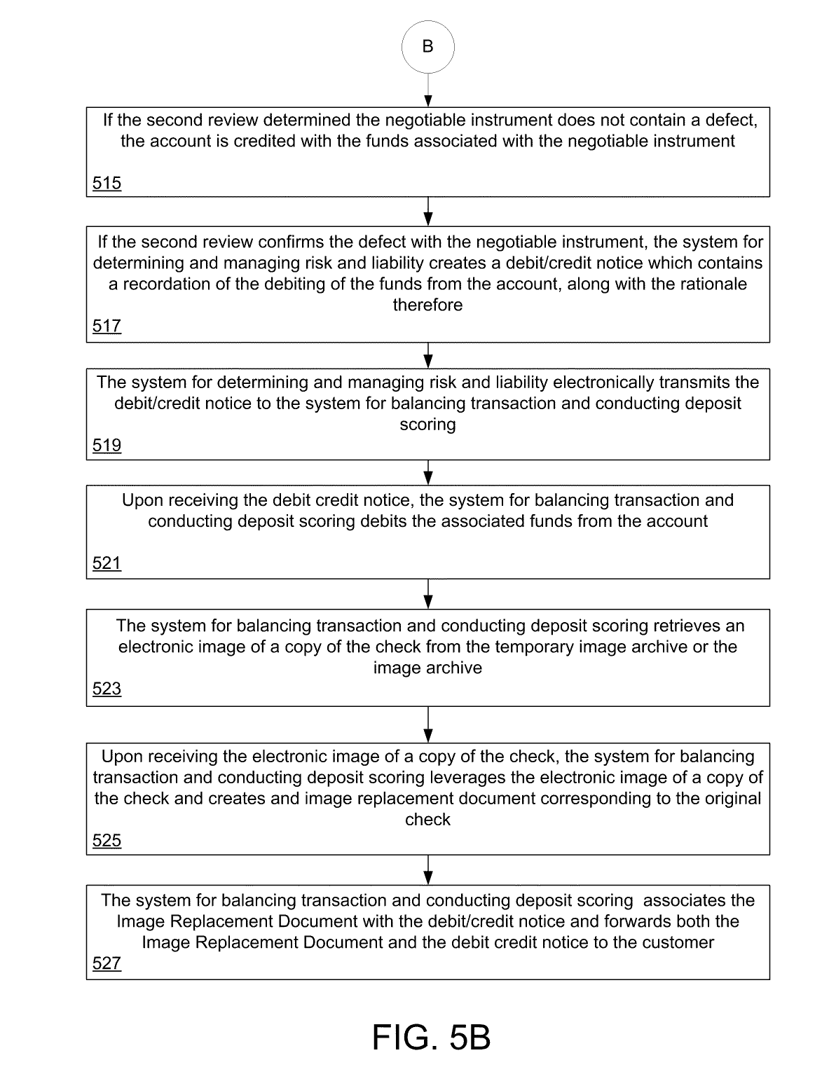

FIGS. 5A and 5B illustrate a flow chart which describes an illustrative process for determining a defect with a negotiable instrument and returning an image replacement document to the customer according to aspects of the disclosure. As seen in FIG. 5A, in step 501 a customer conducts a financial transaction at an automated teller machine (ATM) where the customer submits a negotiable instrument to the bank in order for funds to be deposited into a designated account. In step 503, the funds associated with the negotiable instrument are tentatively credited to the designated account. In step 505, the negotiable instrument is scanned at the ATM to create an electronic image of the negotiable instrument. In step 507, the information submitted by the customer during the financial transaction and the electronic copy of the negotiable instrument are reviewed at the ATM to determine if the negotiable instrument contains any defects that would prevent funds associated with the negotiable instrument from being affirmatively credited to the account designated customer. In step 509, if it is determined that the negotiable Instrument does not contain a defect that would prevent funds associated with the negotiable instrument from being credited to the account, the account is credited with the funds associated with the negotiable instrument. In step 511, if it is determined that the negotiable instrument contains a defect that would prevent funds associated with the negotiable instrument from being credited to the account, the ATM electronically transmits a request to the system for determining and managing risk and liability 215 to conduct a second review of the negotiable instrument and other relevant information from the financial transaction. In step 513, the system for determining and managing risk and liability 215 conducts a second review of the negotiable instrument and other relevant information from the financial transaction. In step 515, if the second review determines the negotiable instrument does not contain a defect, the account is credited with the funds associated with the negotiable instrument. In step 517, if the second review confirms the defect with the negotiable instrument, a DCN is originated for the funds to be debited from the account. It is noted that the DCN may include a recordation of the debiting of the funds from the account, along with the rationale therefore. In step 519, the system for determining and managing risk and liability 215 electronically transmits the DCN to the system for balancing transactions and conducting deposit scoring 217. In step 521, upon receiving the DCN, the system for balancing transactions and conducting deposit scoring 217 debits the associated funds from the account. In step 523, the system for balancing transactions and conducting deposit scoring 217 retrieves an electronic image of a copy of the check from the temporary image archive 211 or the image archive 213. In step 525, upon receiving the electronic image of a copy of the check, the system for the system for balancing transactions and conducting deposit scoring 217 utilizes the electronic image of a copy of the check and creates an image replacement document corresponding to the original check. In step 527, the system for balancing transactions and conducting deposit scoring associates the image replacement document with the DCN and forwards both the image replacement document and the DCN to the customer. It is noted that this process may be conducted done via a computer system as described in detail above.

It is noted that the above described system for processing a negotiable instrument may be an electronically based system, such as a web-based application. For example, the system may include a computer (such as described above), a network of computers, software that configures a computer to perform the above described features, etc. It is noted that according to aspects of the disclosure, the electronically based system for processing a negotiable instrument may include one or more algorithms to perform such tasks automatically.

It is noted that aspects of the above disclosure are not limited to creating IRDs to be returned to the customer when a financial transaction at the ATM is defective. Instead, aspects of the disclosure may relate to creating IRDs from electronic images of negotiable instruments contained in cash letters. For example, if cash letters become corrupted or otherwise compromised, IRDs may be generated as replacements. Further, if the original paper checks are destroyed or inaccessible, IRDs may be created from electronic images of the check. Therefore, it is understood that the above described process of creating the IRDs may be applied to various situations.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present disclosure. The description is thus to be regarded as illustrative instead of restrictive on the present disclosure.

1. A computer comprising:
a processor; and
memory storing computer executable instructions that, when executed, cause the computer to perform a method for preparing an image replacement document, by:
electronically receiving a notification of a potential defect in a negotiable instrument, associated with a financial transaction, uploaded at an automated teller machine (ATM);
electronically receiving an electronic copy of an image of the negotiable instrument uploaded at the ATM;
electronically receiving information regarding the financial transaction which included the negotiable instrument being uploaded at the ATM, wherein the information regarding the financial transaction includes an account number of an account into which funds of the negotiable instrument are to be credited;
determining, based on the electronic copy of the image of the negotiable instrument and the information regarding the financial transaction, whether the potential defect is a defect that prevents an amount of the funds of the negotiable instrument from being credited in account; and
upon determining that the potential defect is a defect that prevents an amount of the funds of the negotiable instrument from being credited in the account, preparing an image replacement document.

2. The computer according to claim 1, wherein the negotiable instrument uploaded at the ATM is a check.

3. The computer according to claim 1, wherein the determining whether the potential defect is a defect that prevents an amount of the funds of the negotiable instrument from being credited in the account includes determining if a payee name on the negotiable instrument of the negotiable instrument is an account holder on the account into which the funds of the negotiable instrument are to be credited.

4. The computer according to claim 1, wherein the determining whether the potential defect is a defect that prevents an amount of the funds of the negotiable instrument from being credited in the account includes determining if there is a proper endorsement on the negotiable instrument.

5. The computer according to claim 1, wherein preparing an image replacement document includes
debiting the account in the amount of the funds of the negotiable instrument when the amount of the funds of the negotiable instrument has been tentatively credited to the account.

6. The computer according to claim 5, wherein preparing an image replacement document includes
creating a document which includes a recordation of the debiting of the account in the amount of the funds of the negotiable instrument and a rationale for the debiting.

7. A computer assisted method for creating and sending a negotiable instrument to an individual comprising:
electronically receiving a notification of a potential defect in a negotiable instrument, associated with a financial transaction, uploaded at an ATM;
electronically receiving an electronic copy of an image of the negotiable instrument uploaded at the ATM;
electronically receiving information regarding the financial transaction which included the negotiable instrument being uploaded at the ATM, wherein the information regarding the financial transaction includes an account number of an account into which funds of the negotiable instrument are to be credited;
using a computer to determine whether the potential defect is a defect that prevents an amount of funds of the negotiable instrument from being credited in the account, wherein the determination is based on a review of the electronic copy of the image of the negotiable instrument and the information regarding the financial transaction;
using a computer to prepare an image replacement document representing the negotiable instrument when it is determined that the potential defect is a defect that prevents the funds of the negotiable instrument from being credited in the account; and
sending the image replacement document to the individual.

8. The method according to claim 7, wherein the negotiable instrument, associated with a financial transaction, uploaded at the ATM is a check.

9. The method according to claim 7, wherein the determining whether the potential defect is a defect that prevents an amount of the funds of the negotiable instrument from being credited in the account includes determining if a payee name on the negotiable instrument is an account holder on the account into which the funds of the negotiable instrument are to be credited.

10. The method according to claim 7, wherein the determining whether the potential defect is a defect that prevents an amount of the funds of the negotiable instrument from being credited in the account includes determining if there is a proper endorsement on the negotiable instrument.

11. The method according to claim 7, further comprising:
debiting the account in the amount of the funds of the negotiable instrument, when the amount of the funds of the negotiable instrument has been tentatively credited to the account.

12. The method according to claim 11, further comprising:
creating a document which includes a recordation of the debiting of the account in the amount of the funds of the negotiable instrument and a rationale for the debiting.

13. The method according to claim 12, further comprising:
sending to the individual the document which includes the recordation of the debiting of the account in the amount of the funds of the negotiable instrument and the rationale for the debiting.

14. A computer assisted method for creating and sending a negotiable instrument to an individual comprising:
electronically receiving an electronic copy of an image of a negotiable instrument, associated with a financial transaction, uploaded at an ATM;
electronically receiving information regarding the financial transaction which included the negotiable instrument being uploaded at the ATM, wherein the information regarding the financial transaction includes an account number of an account into which the funds of the negotiable instrument are to be credited;
using a computer to determine whether the financial transaction included a defect which prevents an amount of the funds of the negotiable instrument from being credited in the account, wherein the determination is based on a review of the electronic copy of the image of the negotiable instrument and the information regarding the financial transaction,
using a computer to prepare an image replacement document representing the negotiable instrument upon determining that the financial transaction contained the defect that prevents an amount the funds of the negotiable instrument from being credited in the account; and
sending the image replacement document to the individual.

15. The method according to claim 14, wherein the negotiable instrument uploaded at the ATM is a check.

16. The method according to claim 14, wherein the determining whether the financial transaction contains a defect that prevents an amount of the funds of the negotiable instrument from being credited in the account includes determining if a payee name on the negotiable instrument is an account holder on the account into which the funds of the negotiable instrument are to be credited.

17. The method according to claim 14, wherein the determining whether the financial transaction contains a defect that prevents an amount of the funds of the negotiable instrument from being credited in the account includes determining if there is a proper endorsement on the negotiable instrument.

18. The method according to claim 14, further comprising:
debiting the account in the amount of the funds of the negotiable instrument, when the amount of the funds associated with the negotiable instrument has been tentatively credited to the account.

19. The method according to claim 18, further comprising:
creating a document which includes a recordation of the debiting of the account in the amount of the funds of the negotiable instrument and a rationale for the debiting.

20. The method according to claim 19, further comprising:
sending to the individual the document which includes the recordation of the debiting of the account in the amount of the funds of the negotiable instrument and the rationale for the debiting.
